(19) United States
(12) Patent Application Publication
(10) Pub. No.: US 2012/0133306 A1
(43) Pub. Date: May 31, 2012

(54) WAVEGUIDE, IN PARTICULAR IN A DIELECTRIC-WALL ACCELERATOR

(76) Inventors: Norbert Seliger, Zorneding (DE); Karl Weidner, Munchen (DE)

(21) Appl. No.: 13/389,253

(22) PCT Filed: Jul. 15, 2010
(86) PCT No.: PCT/EP10/60226

§ 371 Date: Feb. 6, 2012

(30) Foreign Application Priority Data
Aug. 6, 2009 (DE) 10 2009 036 418.8

(51) Int. Cl. H05H 9/00; H01J 9/24

(52) U.S. Cl. 315/506; 445/29

(57) ABSTRACT

The present invention relates to waveguides, e.g., waveguides in a dielectricwall accelerator, and to methods for the manufacture thereof. For example, planar contact electronic assemblies may be integrated in a waveguide e.g., a waveguide of an accelerator cell of a dielectricwall accelerator.

### CROSS-REFERENCE TO RELATED APPLICATIONS

This application is a U.S. National Stage Application of International Application No. PCT/EP2010/060226 filed Jul. 15, 2010, which designates the United States of America, and claims priority to DE Patent Application No. 10 2009 036 418.8 filed Aug. 6, 2009. The contents of which are hereby incorporated by reference in their entirety.

### TECHNICAL FIELD

The present disclosure relates to waveguides, e.g., in a dielectric wall accelerator, and to methods for producing them.

### BACKGROUND

Novel types of waveguides, particularly in a dielectric wall accelerator, are typically no longer of planar design but instead have complex shaped surfaces formed out of a plane. Novel production methods and materials may be required for providing in particular a dielectric for waveguides of such kind. In particular, electronic modules, for example half-bridge circuits or multichip circuits, may be integrated in the waveguide structures, which are hollow conductors.

U.S. Pat. No. 5,821,705 discloses the structure of a conventional dielectric wall accelerator having a high-voltage, fast rise-time switch that has a pair of electrodes laminated between which are alternating layers of isolated conductors and insulators.

### SUMMARY

According to an embodiment, a method for producing a waveguide that has a dielectric or a vacuum between a first and second conductor structure and also has a multiplicity of electronic components on which there are a plurality of top and bottom contact surfaces requiring to be contacted is provided. The method may include securing the electronic components on a substrate, contacting bottom contact surfaces at electric conductors beneath them on the substrate, and producing electric through-contacts extending from the conductors and through the substrate; laminating a foil made of an electrically insulating plastic material onto surfaces of the substrate and of the components arranged thereupon under vacuum so that the foil will tightly cover the surfaces including each electronic component and each top contact surface and will adhere to said surfaces including each electronic component; exposing each top contact surface requiring to be contacted on the surfaces of the electronic components by opening respective windows in the foil; area contacting of each exposed top contact surface by means in each case of a first layer made of an electrically conducting material; securing the substrate having the electronic components on the first conductor structure and electrically contacting top contact surfaces by means of the first layer made of an electrically conducting material and the through-contacts and bottom contact surfaces by means of the through-contacts to the first conductor structure; applying a second layer made of an electrically insulating plastic material to surfaces of the foil, of the first layer made of an electrically conducting material, and of the first conductor structure, with openings being produced in the second layer; and securing the second conductor structure on the second layer, with the second layer embodying the dielectric completely between the first and second conductor structure or, if a vacuum has been produced between the first and second conductor structure, the second layer having been embodied only in the region of the electronic components between the first and second conductor structure and with the top and bottom contact surfaces being electrically contacted to the second conductor structure by means of further through-contacts through the openings in the second layer.

According to a further embodiment, the waveguide forms a constituent part of an accelerator cell of a dielectric wall accelerator and the conductor structures have areas bent out of a plane, with the dielectric or the vacuum having in each case been produced between a top and a central conductor structure and between that and a bottom conductor structure. According to a further embodiment, the bottom and top conductor structure are connected to ground. According to a further embodiment, a polymer film is used as the second layer made of an electrically insulating plastic material. According to a further embodiment, the second layer made of an electrically insulating plastic material is in regions next to the electronic components produced from a plurality of layers made of an electrically insulating plastic material. According to a further embodiment, the second layer made of an electrically insulating plastic material is produced as being bent out of a plane by means of vacuum laminating.

According to a further embodiment, at least one electric external contact link is produced through the openings through the second layer made of an electrically insulating plastic material and/or through a conductor structure, proceeding from the electronic components. According to a further embodiment, an external contact link is a contacting means to a conductor structure. According to a further embodiment, an external contact link is produced by means of a spring contact. According to a further embodiment, an external contact link is produced by means of laser-welded contacts.

According to a further embodiment, the substrate having the electronic components has been secured on the first conductor structure by means of an adhesive foil. According to a further embodiment, the electronic components are a power module. According to a further embodiment, a material of a dielectric and/or of the second layer is mechanically elastic. According to a further embodiment, a material of the conductor structures is steel having a metal coating of copper.

According to an embodiment, a device having a waveguide that has a dielectric or vacuum between a first and second conductor structure and also has a multiplicity of electronic components on which there are a plurality of top and bottom contact surfaces requiring to be contacted is provided, with the electronic components having been secured on a substrate and bottom contact surfaces at electric conductors beneath them having been electrically contacted on the, and electric through-contacts having been produced through the substrate by the conductors; a foil made of an electrically insulating plastic material having been laminated onto surfaces of the substrate and of the components arranged thereupon under a vacuum so that the foil will tightly cover the surfaces including each electronic component and each top contact surface and will adhere to said surfaces including each electronic component; each top contact surface requiring to be contacted on the surfaces of the electronic components having been exposed by opening respective windows in the foil; each exposed top contact surface having been area contacted by means in each case of a first layer of electrically conducting material; the substrate having the electronic components having been secured on the first conductor structure and top contact surfaces having been electrically contacted by means of the first layer made of an electrically conducting material and the through-contacts and bottom contact surfaces having been electrically contacted to the first conductor structure by means of the through-contacts; a second layer made of an electrically insulating plastic material having been applied to surfaces of the foil, of the first layer of electrically conducting material, and of the first conductor structure; the second conductor structure having been secured on the second layer, with the second layer embodying the dielectric completely between the first and second conductor structure or, if a vacuum has been produced between the first and second conductor structure, the second layer having been embodied only in the region of the electronic components between the first and second conductor structure and with the second layer having openings through which top and bottom contact surfaces have been electrically contacted to the second conductor structure by means of further through-contacts.

According to a further embodiment, the waveguide forms a constituent part of an accelerator cell of a dielectric wall accelerator and the conductor structures have areas bent out of a plane, with the dielectric or the vacuum having in each case been produced between a top and a central conductor structure and between that and a bottom conductor structure. According to a further embodiment, the bottom and top conductor structure are connected to ground. According to a further embodiment, the second layer made of an electrically insulating plastic material is a polymer film. According to a further embodiment, the second layer made of an electrically insulating plastic material is in regions next to the electronic components produced from a plurality of layers made of an electrically insulating plastic material. According to a further embodiment, the second layer made of an electrically insulating plastic material was produced as being bent out of a plane by means of vacuum laminating.

According to a further embodiment, at least one electric external contact link was produced through the openings through the second layer made of an electrically insulating plastic material and/or through a conductor structure, proceeding from the electronic components. According to a further embodiment, an external contact link is a contacting means to a conductor structure. According to a further embodiment, an external contact link is produced by means of a spring contact. According to a further embodiment, an external contact link is produced by means of laser-welded contacts. According to a further embodiment, the substrate having the electronic components has been secured on the first conductor structure by means of an adhesive foil. According to a further embodiment, the electronic components are a power module. According to a further embodiment, a material of a dielectric and/or of the second layer is mechanically elastic.

According to a further embodiment, a material of the conductor structures is steel having a metal coating of copper.

### BRIEF DESCRIPTION OF THE DRAWINGS

Example embodiments are described in more detail below with reference to the figures, in which:

FIG. 1 shows a multi-stage system of a conventional dielectric wall accelerator;

FIG. 2 shows a single accelerator cell of a conventional dielectric wall accelerator;

FIG. 3 shows a left-hand half of a conventional accelerator cell in cross-section with conventional terminals of a switch on conductor structures;

FIG. 4 shows a first exemplary embodiment of a device according to certain embodiments;

FIG. 5 shows a second exemplary embodiment of a device according to certain embodiments;

FIG. 6 shows a third exemplary embodiment of a device according to certain embodiments;

FIG. 7 shows another conventional exemplary embodiment of conductor structures;

FIG. 8 shows an example method according to certain embodiments.

### DETAILED DESCRIPTION

Certain embodiments employ dielectric layers to improve or stabilize a dielectric strength and preclude insulation-reducing effects in waveguide structures, particularly in complex metallic waveguide structures formed out of a plane. Electric insulation up to 100 kV/mm with small dielectric constants may be provided. A multiplicity of electronic components may be integrated in the waveguide structures. In particular a multiplicity of electronic components for driving an accelerator cell of a dielectric wall accelerator may be integrated in the accelerator cell. In some embodiments, a compact, economical assembling and connecting system for electronic components is provided. Some embodiments may be able to minimize parasitic effects and provide for a multiplicity of electronic components to be effectively linked to the waveguide structures on a high-frequency basis.

According to some embodiments, a method is provided for producing a waveguide that has a dielectric or vacuum between a first and second conductor structure and also has a multiplicity of electronic components on which there are a plurality of top and bottom contact surfaces requiring to be contacted. The method may include the following steps: securing the electronic components on a substrate, contacting bottom contact surfaces at electric conductors beneath them on the substrate, and producing electric through-contacts extending from the conductors and through the substrate; laminating a foil made of an electrically insulating plastic material onto surfaces of the substrate and of the components arranged thereupon under a vacuum so that the foil will tightly cover the surfaces including each electronic component and each top contact surface and will adhere to said surfaces including each electronic component; exposing each top contact surface requiring to be contacted on the electronic components' surfaces by opening respective windows in the foil; area contacting of each exposed top contact surface by means in each case of a first layer made of an electrically conducting material; securing the substrate having the electronic components on the first conductor structure and electrically contacting top contact surfaces by means of the first layer made of an electrically conducting material and the through-contacts and bottom contact surfaces by means of the through-contacts to the first conductor structure; applying a second layer made of an electrically insulating plastic material to surfaces of the foil, of the first layer made of an electrically conducting material, and of the first conductor structure, with openings being produced in the second layer; securing the second conductor structure on the second layer, with the second layer embodying the dielectric completely between the first and second conductor structure or, if a vacuum has been produced between the first and second conductor structure, the second layer having been embodied only in the region of the electronic components between the first and second conductor structure and with the top and bottom contact surfaces being electrically contacted to the second conductor structure by means of further through-contacts through the openings in the second layer.

According to some embodiments, a device may have a waveguide that has a dielectric or vacuum between a first and second conductor structure and also has a multiplicity of electronic components on which there are a plurality of top and bottom contact surfaces requiring to be contacted, with the electronic components having been secured on a substrate and bottom contact surfaces at electric conductors beneath them having been electrically contacted on the substrate, and electric through-contacts having been produced through the substrate by the conductors; with a foil made of an electrically insulating plastic material having been laminated onto surfaces of the substrate and of the components located thereupon under a vacuum so that the foil will tightly cover the surfaces including each electronic component and each top contact surface and will adhere to said surfaces including each electronic component; with each top contact surface requiring to be contacted on the electronic components' surfaces having been exposed by opening respective windows in the foil; with each exposed top contact surface having been area contacted by means in each case of a first layer made of an electrically conducting material; with the substrate having the electronic components having been secured on the first conductor structure and top contact surfaces having been electrically contacted by means of the first layer made of an electrically conducting material and the through-contacts and bottom contact surfaces having been electrically contacted by means of the through-contacts to the first conductor structure; with a second layer made of an electrically insulating plastic material having been applied to surfaces of the foil, of the first layer made of an electrically conducting material, and of the first conductor structure; and with the second conductor structure having been secured on the second layer, with the second layer embodying the dielectric completely between the first and second conductor structure or, if a vacuum has been produced between the first and second conductor structure, the second layer having been embodied only in the region of the electronic components between the first and second conductor structure and with the second layer having openings through which top and bottom contact surfaces have been electrically contacted to the second conductor structure by means of further through-contacts.

In some embodiments, a method for producing a plurality of modules includes the following main steps: vacuum laminating, molding, use of inkjet processes for linking the dielectric-layer to the waveguide structures or, as the case may be, coating it with them, and integrating the electronic components, which here can be power modules contacted in planar fashion. What will be provided is a highly insulating covering for initially open end faces of waveguide structures. A compact, flat, lightweight construction may furthermore be made possible, specifically having short, precise line lengths and line widths. What may take place is system integrating of modules contacted in planar fashion in a waveguide. In some embodiments, minimum path lengths to the waveguide may be provided through integrating electronic components in the waveguides. That may result in minimal parasitic effects and effective high-frequency linking.

According to an example advantageous embodiment, the waveguide can form a constituent part of an accelerator cell of a dielectric wall accelerator and the conductor structures can have areas formed out of a plane. The dielectric or vacuum can in each case be arranged between a top and central conductor structure and between that and a bottom conductor structure. A waveguide that has been produced according to a method as claimed in the principal claim can hence be integrated in an accelerator cell of a dielectric wall accelerator. A stack of waveguides can hence be produced. There can be a multi-layer structure, with it being possible to use different dielectric or vacuum layers.

According to another example advantageous embodiment, the bottom and top conductor structure can be connected to ground.

According to another example advantageous embodiment, the second layer made of an electrically insulating plastic material can be a polymer film. The dielectric will be particularly advantageous if provided as a polymer film that is suitable for high-frequency operation, super-insulating, and suitable for high-temperature applications.

According to another example advantageous embodiment, the second layer made of an electrically insulating plastic material can in the region next to the electronic components have been produced from a plurality of layers made of an electrically insulating basic material. A suitable thickness can be produced by structuring the second layer in layers. That can be done by employing multiple layers. Insulation-reducing effects due to, for instance, missing parts of the dielectric can be precluded thereby. A multi-layer dielectric layer structure will produce redundancy in dielectric-strength terms.

According to another example advantageous embodiment, the second layer made of an electrically insulating plastic material can have been produced as being bent out of a plane by means of vacuum laminating. A vacuum-laminating process in an autoclave with suitable layers of dielectrics will make geometrically complex three-dimensional shaping of waveguide structures possible. Air inclusions will be particularly advantageously prevented for improving and stabilizing the dielectric strength. A vacuum-laminating method is suitable for complex shaping and hence for larger molded parts.

According to another example advantageous embodiment, at least one electric external contact link can have been produced through the openings through the second layer made of an electrically insulating material and/or through a conductor structure, proceeding from the electronic components. Electronic components can in that way have connection elements to the waveguide structures. The waveguide structures can be connected to the electronic components with very low inductance by a direct external link.

According to another example advantageous embodiment, an external contact link can be a contacting means to a conductor structure.

According to another example advantageous embodiment, an external contact link can have been produced by means of a spring contact.

According to another example advantageous embodiment, an external contact link can have been produced by means of laser-welded contacts. The waveguide structures can have been connected to the electronic components with very low inductance by a direct external link, in particular by laser-welded contacts. That can be done by means of, for example, a copper lead frame. External contacts can have been provided directly on the waveguide by means of, for example, laser-welded copper lead frames.

According to another example advantageous embodiment, the substrate having the electronic components can have been secured by its side facing away from the components to the first conductor structure by means of an adhesive foil.

According to another example advantageous embodiment, the electronic components can be a power module. Electronic modules, for example half-bridge circuits or multi-chip circuits, can be integrated in the waveguide in that way.

According to another example advantageous embodiment, a material of the dielectric or of the second layer made of an electrically insulating material can be mechanically elastic. A flexible material will be able to accommodate mechanical stresses which may have been caused by, for instance, thermal expansion of the waveguide or inductive or electrostatic deformation.

According to another example advantageous embodiment, the waveguide can have been given a functional metal coating with the aim specifically of improving electric properties. That can also be combined with a multi-layer structure. A material of the conductor structures can particularly advantageously be steel having a metal coating of copper.

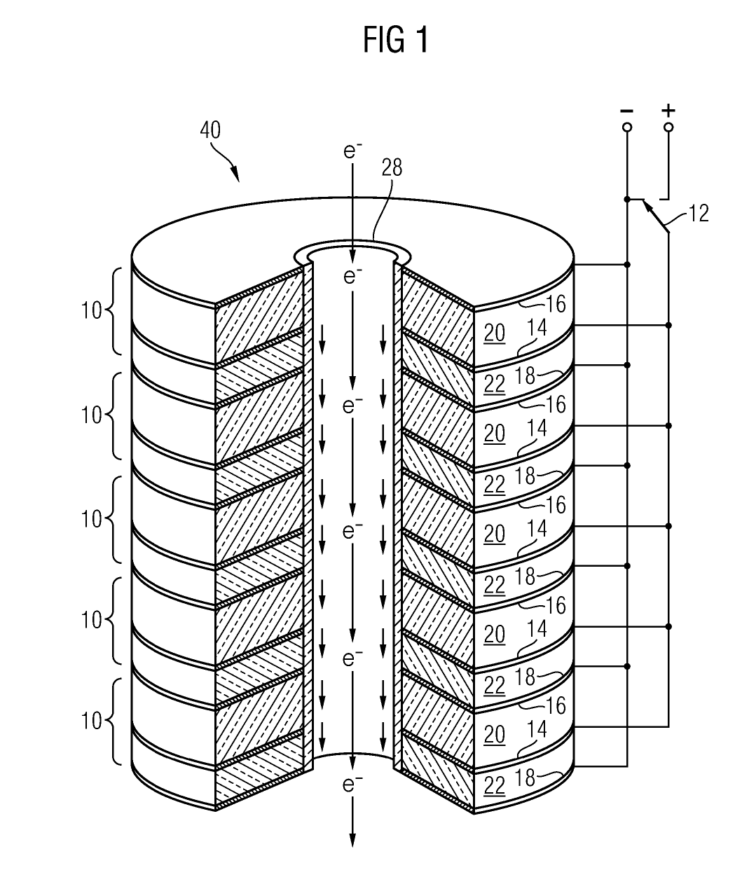

FIG. 1 shows a multi-stage system 40 of a linear accelerator of a conventional dielectric wall accelerator for use in a vacuum chamber. Five accelerator cells 10 are shown that all share a common stack having a dielectric sleeve 28. Each accelerator cell 10 has conductor structures 14, 16, and 18. A laminated dielectric 20 separates conductor structures 14 and 16. A laminated dielectric 22 separates conductor structures 14 and 18. A switch 12 has been connected to enable central conductor structure 14 to be charged by a high-voltage source. A particle beam e⁻ is accelerated in an axial channel through driving of individual accelerator cells 10.

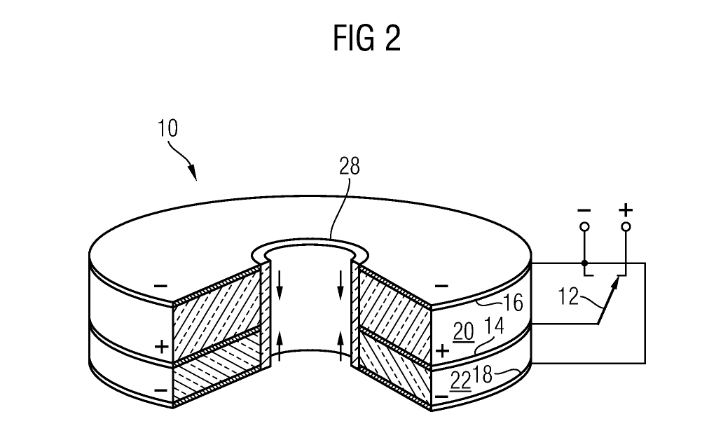

FIG. 2 shows a single conventional accelerator cell 10, having a pair of top and bottom conductor structures 16 and 18, and a central conductor structure 14. A laminated dielectric 20 has been produced between conductor structures 14 and 16. A laminated dielectric 22 has furthermore been produced between conductor structures 14 and 18. Reference numeral 28 identifies a dielectric sleeve. Provided inside said dielectric sleeve 28 is a channel in which a particle beam e⁻ is accelerated. Individual accelerator cell 10 is driven by means of a switch 12.

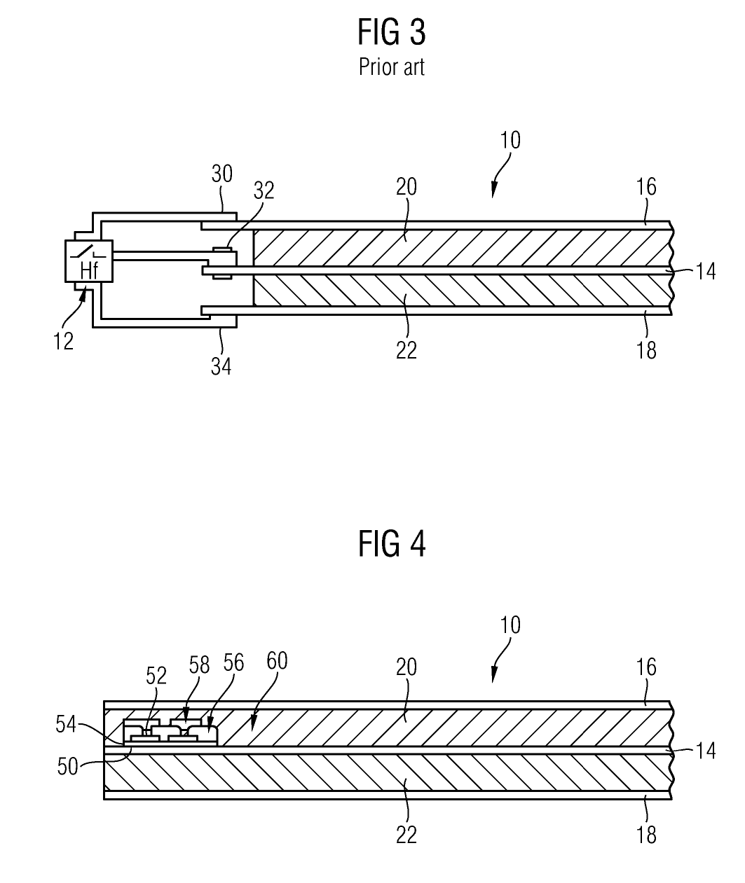

FIG. 3 shows a left-hand half of a conventional accelerator cell 10 in cross-section. The elements therein correspond to the elements shown in the preceding figures. FIG. 3 shows conventional terminals of a switch 12 to conductor structures 14, 16, and 18. Shown therein are a welded joint 30, a screwed joint 32, and a soldered joint 34. A switch 12 has in that way been electrically contacted to conductor structures 14, 16, and 18.

FIG. 4 shows a device according to certain embodiments of the present disclosure. An arrangement as shown in FIG. 4 can therein be an accelerator cell 10 of a dielectric wall accelerator. The device as shown in FIG. 4 therein has a dielectric 20 between a first and second conductor structure 14 and 16. Dielectric 20 and conductor structures 14 and 16 produce a waveguide. It is possible instead of dielectric 20 for a vacuum to have been produced. According to FIG. 4, a multiplicity of electronic components 50 are integrated in the top waveguide. On electronic components 50 there are a plurality of top and bottom contact surfaces 52 requiring to be contacted. Electronic components 50 can be secured on a substrate 54. A foil 56 made of an electrically insulating plastic material has been laminated under vacuum onto surfaces of substrate 54 and of components 50 arranged thereupon so that foil 56 will tightly cover the surfaces including each electronic component 50 and each top contact surface 52 and will adhere to said surfaces including each electronic component 50. Each top contact surface 52 requiring to be contacted on the surfaces of electronic components 50 was exposed by opening respective windows in foil 56. Each exposed top contact surface 52 area was contacted by means in each case of a first layer 58 of electrically conducting material. Substrate 54 having electronic components 50 secured thereupon was secured by its side facing away from the components to first conductor structure 14. Electronic components 50 secured on substrate 54 were therein integrated in the waveguide at its end in such a way that an acceleration channel can have been arranged opposite. That means that electronic components 50 have been integrated in the waveguide at the radially outer end of the waveguide of accelerator cell 10. Open end faces of waveguide structures will in that way be covered in a super-insulating manner. A second layer 60 made of an electrically insulating plastic material was applied to surfaces of foil 56, to first layer 58 made of an electrically conducting material, and to first conductor structure 14. Second conductor structure 16 was secured on second layer 60, with second layer 60 embodying dielectric 20 between first and second conductor structure 14 and 16. According to an embodiment variant, the above-described waveguide can form a constituent of an accelerator cell 10 of a dielectric wall accelerator in which conductor structures 14, 16, 18 have areas bent out of a plane. Dielectric 20 and 22 or a vacuum has in each case been arranged between a top and central conductor structure 14 and 16 and between that and a bottom conductor structure 14 and 18. U.S. Pat. No. 5,821,705, which is hereby incorporated by reference in its entirety, provides example details of the operation of a dielectric wall accelerator.

FIG. 5 shows another exemplary embodiment of a waveguide and of an accelerator cell 10 of a dielectric wall accelerator. The electronic components on the left-hand side of accelerator cell 10 therein display the same features as shown in FIG. 4. The only difference is that electronic components 50 have been integrated in a bottom waveguide. In addition to FIG. 4, produced in FIG. 5 proceeding from electronic components 50 are electric external contact links 62 which extend from electronic components 50 through second layer 60 made of an electrically insulating plastic material and through conductor structure 18. The electric external contact links are identified by reference numeral 62. According to FIG. 5, an external contact link 62 to conductor structure 14 has been produced by means of a spring contact 64.

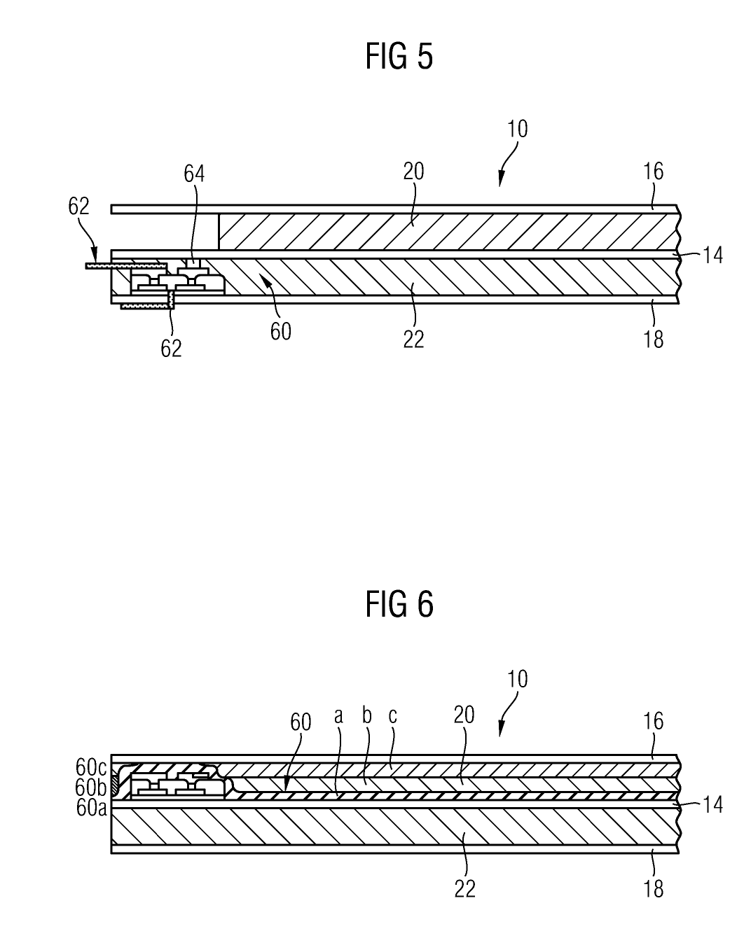

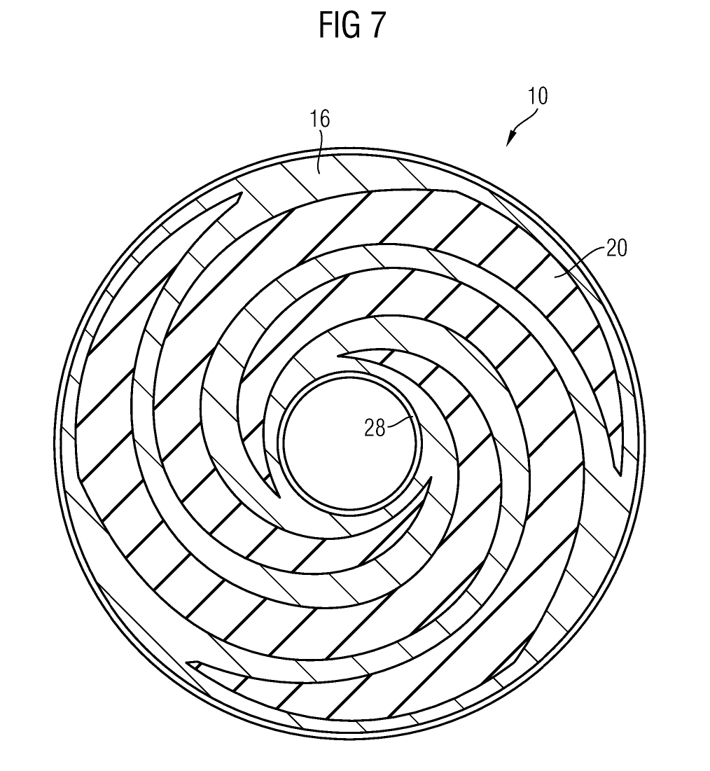

Another exemplary embodiment is shown according to FIG. 6. In contrast to FIG. 4, second layer 60 made of an electrically insulating plastic material has in regions next to electronic components 50 been produced from a plurality of layers 60a, 60b, 60c made of an electrically insulating plastic material. A gap between first conductor structure 14 and second conductor structure 16 will be advantageously filled in that way. The gap next to components 50 will be filled by additional layers 60b and 60c. Only layer 60a is required for filling a gap between components 50 and second conductor structure 16. The spacing between conductor structures 14 and 14 will thus have been provided as uniform.

FIG. 7 illustrates one example of a compact way to replace the fixed disks of conductor structures 14, 16, and 18, with one or more spiral conductors being provided that are connected between conductor rings to the inner and outer diameter. Reference numeral 16 identifies a top conductor structure 16 and reference numeral 20 identifies a dielectric. Reference numeral 28 identifies a dielectric sleeve. FIG. 7 is a view onto an accelerator cell 10.

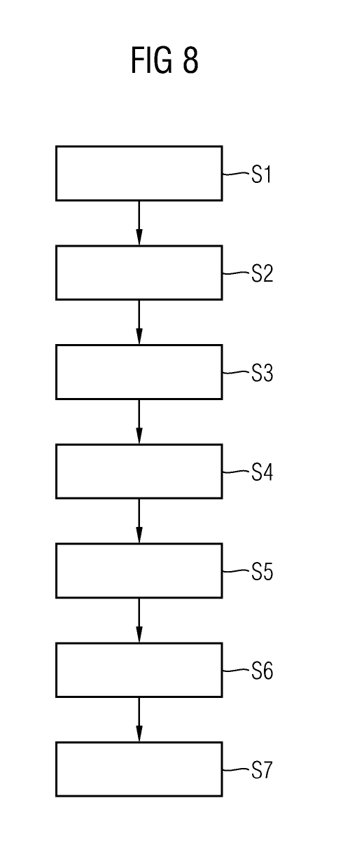

FIG. 8 shows an example embodiment of a method for producing a waveguide that has a dielectric 20 or a vacuum between a first and second conductor structure 14 and 16 and also has a multiplicity of electronic components 50 on which there are in each case one or more top and bottom contact surfaces 52 requiring to be contacted. The method comprises the following steps: Step S1: Securing the electronic components 50 on a substrate 54, contacting bottom contact surfaces 52 at electric conductors beneath them on substrate 54, and producing electric through-contacts extending from the conductors through substrate 54. Step S2: Laminating a foil 56 made of an electrically insulating plastic material onto surfaces of substrate 54 and of components 50 arranged thereupon under a vacuum so that foil 56 will tightly cover the surfaces including each electronic component 50 and each top contact surface 52 will adhere to said surfaces including each electronic component 50. Step S3: Exposing each top contact surface 52 requiring to be contacted on the surfaces of electronic components 50 by opening respective windows in foil 56. Step S4: Area contacting of each exposed top contact surface 52 by means in each case of a first layer 58 of electrically conducting material. Step S5: Securing substrate 54 having electronic components 50 on first conductor structure 14 and electrically contacting top contact surfaces 52 by means of first layer 58 made of an electrically conducting material and the through-contacts and bottom contact surfaces 52 by means of the through-contacts to first conductor structure 14. Step S6: Applying a second layer 60 made of an electrically insulating plastic material to surfaces of foil 56, to first layer 58 made of an electrically conducting material, and to first conductor structure 14, with openings being produced in second layer 60. Step S7: Securing second conductor structure 16 on second layer 60, with second layer 60 embodying dielectric 20 completely between first and second conductor structure 14, 16 or, if a vacuum has been produced between first and second conductor structure 14, 16, second layer 60 having been embodied only in the region of electronic components 50 between first and second conductor structure 14, 16 as an optional dielectric and with top and bottom contact surfaces 52 being electrically contacted to second conductor structure 16 by means of further through-contacts through the openings in second layer 60. A top contact surface 52 can therein be electrically connected to second conductor structure 16 by means of first layer 58 made of an electrically conducting material and the further through-contacts. A bottom contact surface 52 can be electrically connected to second conductor structure 16 by means of the electric conductor on substrate 54 and the further through-contacts through foil 56 made of an electrically insulating plastic material and through second layer 60 made of an electrically insulating plastic material. Each contact surface 52 can if required of course have been assigned a separate through-contact.

What is claimed is:

1. A method for producing a waveguide that has a dielectric or a vacuum between a first and second conductor structure and also has a multiplicity of electronic components on which there are a plurality of top and bottom contact surfaces requiring to be contacted, comprising:
securing the electronic components on a substrate, contacting bottom contact surfaces at electric conductors beneath them on the substrate, and producing electric through-contacts extending from the conductors and through the substrate;
laminating a foil made of an electrically insulating plastic material onto surfaces of the substrate and of the components arranged thereupon under vacuum so that the foil will tightly covers the surfaces including each electronic component and each top contact surface and adheres to said surfaces including each electronic component;
exposing each top contact surface arranged to be contacted on the surfaces of the electronic components by opening respective windows in the foil;
area contacting of each exposed top contact surface by means in each case of a first layer made of an electrically conducting material;
securing the substrate having the electronic components on the first conductor structure and electrically contacting top contact surfaces by means of the first layer made of an electrically conducting material and the through-contacts and bottom contact surfaces by means of the through-contacts to the first conductor structure;
applying a second layer made of an electrically insulating plastic material to surfaces of the foil, of the first layer made of an electrically conducting material, and of the first conductor structure, with openings being produced in the second layer; and
securing the second conductor structure on the second layer, with the second layer embodying the dielectric completely between the first and second conductor structure or, if a vacuum is produced between the first and second conductor structure, the second layer being embodied only in the region of the electronic components between the first and second conductor structure and with the top and bottom contact surfaces being electrically contacted to the second conductor structure by means of further through-contacts through the openings in the second layer.

2. The method of claim 1, wherein the waveguide forms a constituent part of an accelerator cell of a dielectric wall accelerator and the conductor structures have areas bent out of a plane, with the dielectric or the vacuum having in each case been produced between a top and a central conductor structure and between that and a bottom conductor structure.

3. The method of claim 2, wherein the bottom and top conductor structure are connected to ground.

4. The method of claim 1, wherein a polymer film is used as the second layer made of an electrically insulating plastic material.

5. The method of claim 1, wherein the second layer made of an electrically insulating plastic material is in regions next to the electronic components produced from a plurality of layers made of an electrically insulating plastic material.

6. The method of claim 1, wherein the second layer made of an electrically insulating plastic material is produced as being bent out of a plane by means of vacuum laminating.

7. The method of claim 1, wherein at least one electric external contact link is produced through the openings through the second layer made of an electrically insulating plastic material and/or through a conductor structure, proceeding from the electronic components.

8. The method of claim 7, wherein an external contact link is a contacting means to a conductor structure.

9. The method of claim 7, wherein an external contact link is produced by means of a spring contact.

10. The method of claim 7, wherein an external contact link is produced by means of laser-welded contacts.

11. The method of claim 1, wherein the substrate having the electronic components has been secured on the first conductor structure by means of an adhesive foil.

12. The method of claim 1, wherein the electronic components are a power module.

13. The method of claim 1, wherein a material of dielectric and/or of the second layer is mechanically elastic.

14. The method of claim 1, wherein a material of the conductor structures is steel having a metal coating of copper.

15. A device having a waveguide that has a dielectric or vacuum between a first and second conductor structure and also has a multiplicity of electronic components on which there are a plurality of top and bottom contact surfaces requiring to be contacted;
wherein the electronic components are secured on a substrate and bottom contact surfaces at electric conductors beneath them are electrically contacted on the substrate, and electric through-contacts are produced through the substrate by the conductors;
wherein a foil made of an electrically insulating plastic material is laminated onto surfaces of the substrate and of the components arranged thereupon under a vacuum so that the foil tightly covers the surfaces including each electronic component and each top contact surface and adheres to said surfaces including each electronic component;
wherein each top contact surface arranged to be contacted on the surfaces of the electronic components are exposed by opening respective windows in the foil;
wherein each exposed top contact surface is area contacted by means in each case of a first layer of electrically conducting material;
wherein the substrate having the electronic components is secured on the first conductor structure and top contact surfaces are electrically contacted by means of the first layer made of an electrically conducting material and the through-contacts and bottom contact surfaces are electrically contacted to the first conductor structure by means of the through-contacts;
wherein a second layer made of an electrically insulating plastic material is applied to surfaces of the foil, of the first layer of electrically conducting material, and of the first conductor structure;
wherein the second conductor structure is secured on the second layer, with the second layer embodying the dielectric completely between the first and second conductor structure or, if a vacuum has been produced between the first and second conductor structure, the second layer is embodied only in the region of the electronic components between the first and second conductor structure and with the second layer having openings through which top and bottom contact surfaces are electrically contacted to the second conductor structure by means of further through-contacts.

16. The device of claim 15, wherein the waveguide forms a constituent part of an accelerator cell of a dielectric wall accelerator and the conductor structures have areas bent out of a plane, with the dielectric or the vacuum being produced between a top and a central conductor structure and between that and a bottom conductor structure.

17. The device of claim 16, wherein the bottom and top conductor structure are connected to ground.

18. (canceled)

19. The device of claim 15, wherein the second layer made of an electrically insulating plastic material is in regions next to the electronic components produced from a plurality of layers made of an electrically insulating plastic material.

20. The device of claim 15, wherein the second layer made of an electrically insulating plastic material is produced as being bent out of a plane by means of vacuum laminating.

21. The device of claim 15, wherein at least one electric external contact link is produced through the openings through the second layer made of an electrically insulating plastic material and/or through a conductor structure, proceeding from the electronic components.

22-28. (canceled)
